(19) United States
(12) Patent Application Publication
(10) Pub. No.: US 2022/0221615 A1
(43) Pub. Date: Jul. 14, 2022

(54) RESERVOIR TURNING BANDS SIMULATION WITH DISTRIBUTED COMPUTING

(71) Applicant: Landmark Graphics Corporation, Houston, TX (US)

(72) Inventors: Genbao Shi, Sugar Land, TX (US); Gaetan Pierre Louis Bardy, Artiguelouve (FR); Mehran Hassanpour, Houston, TX (US); Jeffrey Marc Yarus, Shaker Heights, OH (US)

(21) Appl. No.: 17/595,654

(22) PCT Filed: Feb. 14, 2020
(86) PCT No.: PCT/US2020/018207

§ 371 Date: Nov. 22, 2021

Related U.S. Application Data
(60) Provisional application No. 62/891,184, filed on Aug. 23, 2019.

(51) Int. Cl. G01V 99/00; E21B 44/02

(52) U.S. Cl. CPC G01V 99/005; E21B 2200/20; E21B 44/02

(57) ABSTRACT

A reservoir model for values of a formation property is simulated using a turning bands method with distributed computing. A distributed computing system simulates the reservoir on separate machines in parallel in several stages. First, line distributions are simulated independently on turning bands. The reservoir model is partitioned into tiles and unconditional simulations are run on each tile in parallel using the corresponding simulated turning bands. The unconditional simulations within each tile are conditioned on known formation values to generate conditional simulations. Conditional simulations are aggregated across tiles to create the simulated reservoir model.

### BACKGROUND

The disclosure generally relates to the field of geostatistics, data processing, and modeling.

Geostatistical simulations comprise a set of techniques that use uncertainty in spatial estimation to capture the heterogeneous properties of geological reservoir formations. Most geostatistical simulations generate a stochastic (random) process that extends known reservoir data to formation property values at unknown locations.

The turning bands method is a method for simulation of a stochastic process that captures heterogeneity in reservoir formations. This method simulates the stochastic process on a chosen set of lines (turning bands) around a fixed origin and interpolates values throughout a geostatistical model based on the simulated values on the turning bands. Distributions of the stochastic process on each line are chosen to reflect anisotropic trends in the formation but do not necessarily coincide with known reservoir data. The resulting unconditional simulation is conditioned on the reservoir data to generate the simulated reservoir model.

### BRIEF DESCRIPTION OF THE DRAWINGS

FIG. 1 is a conceptual diagram of a reservoir modeling system using distributed computing.

FIG. 2 is a flowchart of example operations for running an unconditional reservoir simulation using distributed computing.

FIG. 3 is a flowchart of example operations for running a conditional reservoir simulation using distributed computing.

FIG. 4 depicts an example computer system with a reservoir modeling system that implements distributed computing.

FIG. 5 depicts a schematic diagram of a wireline system with a reservoir modeling system that implements distributed computing.

FIG. 6 depicts a schematic diagram of a drilling rig system with a reservoir modeling system that implements distributed computing.

FIG. 7 is a flowchart of example operations for running a conditional reservoir simulation.

### DESCRIPTION

The description that follows includes example systems, methods, techniques, and program flows that embody aspects of the disclosure. However, it is understood that this disclosure may be practiced without these specific details. For instance, this disclosure refers to reservoir modeling in illustrative examples. Aspects of this disclosure can be instead applied to other types of models involving spatiotemporal datasets. In other instances, well-known instruction instances, protocols, structures, and techniques have not been shown in detail in order not to obfuscate the description.

Overview

The turning bands method for geostatistical reservoir simulation typically suffers from a computational bottleneck as the number of points in the reservoir model scales into the billions. Running the turning bands method on a single machine can be prohibitively slow. The geostatistical simulation method developed herein uses the structure of the reservoir model and parallelizability of certain steps in the turning bands method to enable the distribution of computing resources for reservoir model generation among several machines in a distributed computing system.

A client application or client-facing API (hereinafter “client”) retrieves reservoir data that represents a reservoir formation to be simulated. The client further specifies the size and boundary of the formation that will correspond to the reservoir model and selects parameters to run the turning bands simulation, such as a fixed origin, a set of lines with corresponding directions passing through the origin, coordinates of unknown locations to be modeled, etc. The client sends the well data and simulation parameters to the distributed computing system. The distributed computing system receives the well data and simulation parameters and runs an unconditional (i.e. not conditioned on known reservoir data) simulation by sampling distributions on each line. A controller node in the distributed computing system delegates several sub-nodes (machines) to sample distributions from one or several lines. Since the distributions are independent, this step is parallelizable.

This unconditional simulation models anisotropic trends in the formation but is not aligned with the reservoir data at the locations where formation property values are known. The distributed computing system generates conditional simulations in a series of steps to reconcile these differences. First, the formation being modeled is split into various tiles. The controller node sends unconditional simulation data and known reservoir data corresponding to each tile to various sub-nodes. Each sub-node can receive data for one tile or several tiles and can compute conditional simulations based on the data for the one or several tiles. The sub-nodes interpolate reservoir values for unknown locations using the unconditional simulation data and then condition the resulting interpolated values on the reservoir data. Since the conditional simulations for each tile are generated independently of each other, the sub-nodes can run conditional simulations in parallel. The controller node aggregates conditional simulations for each tile and sends the resulting reservoir model comprising the aggregated conditional simulations to the client. Running conditional simulations on tiles that are much smaller than the whole reservoir model can save an order of magnitude in computational time for reservoir model generation.

Example Illustrations

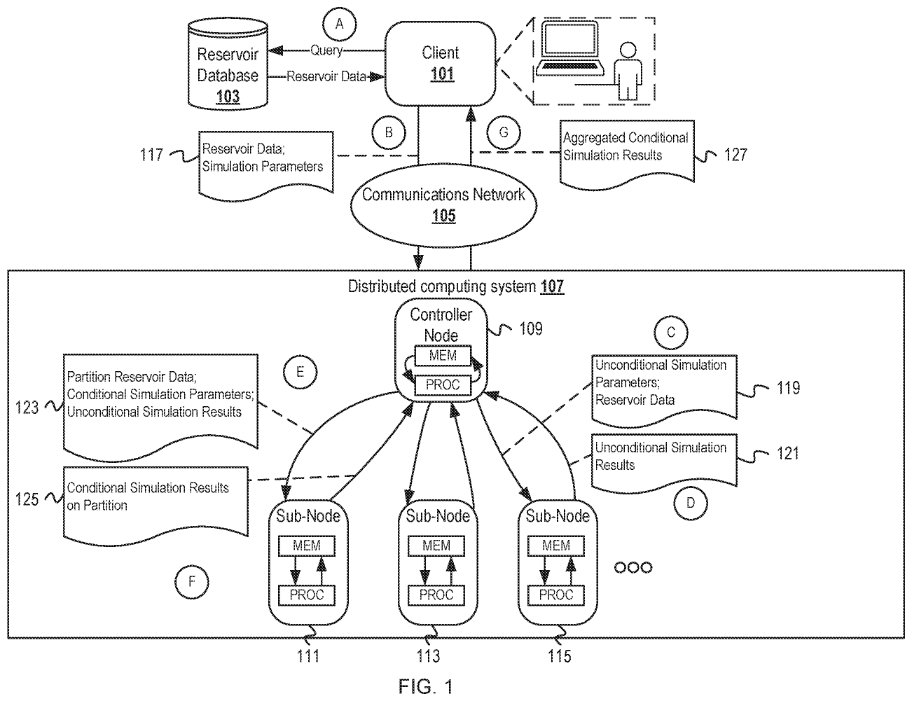

FIG. 1 is a conceptual diagram of a reservoir modeling system that decomposes a turning band reservoir simulation into independent simulations across a distributed computing system. A client-facing interface (“client”) 101 is communicatively coupled to a reservoir database 103 and communicatively coupled to a distributed computing system 107 via a communications network 105. The distributed computing system 107 comprises a controller node 109 that is communicatively coupled to sub-node 111, sub-node 113, and sub-node 115. The nodes 109, 111, 113, 115 each comprise a processor PROC and memory MEM in communication with one another.

Distributed computing system 107 is a particular embodiment of a system that operates by delegating computing tasks in parallel to multiple computing resources. Although the controller node 109 is depicted as communicatively coupled with sub-nodes 111, 113, and 115, the distributed computing system 107 can have any number of nodes internally communicatively coupled in any configuration that enables parallel computation. The controller nodes and sub-nodes can be any type of machine that has computing resources and runs on a virtual or physical server. The controller node 109 and sub-nodes 111, 113, and 115 can have access to a shared memory that can be stored on a relational or non-relational database (e.g. SQL, NoSQL). Computing resources running on nodes in the distributed computing system 107 can be optimized to run in parallel by, for example, minimizing internal node communications during certain computations.

FIG. 1 is annotated with a series of letters A through G. Although these stages are ordered for this example, the stages illustrate one example to aid in understanding this disclosure and should not be used to limit the claims. Subject matter falling within the scope of the claims can vary with respect to the order and some of the operations. Although stages C through F arc depicted as occurring between a sub-node and the controller node 109, any of these operations can occur between multiple sub-nodes and the controller node 109. Moreover, data 119, 121, 123, 125 can be stored in shared memory instead of transferred between nodes.

At stage A, the client 101 queries the reservoir database 103 for reservoir data corresponding to a reservoir formation to be modeled. The query can comprise a reservoir size, reservoir boundary, and a list of formation property types which can be automated or specified by the client 101. The reservoir data comprises a set of known data points and a set of unknown data points. Each known data point comprises coordinates and a list of formation property values at the coordinates, and each unknown data point comprises coordinates. Formation properties can include formation temperature, pressure, porosity, compressibility, and any other spatially dependent formation properties. The reservoir data can further comprise a latitude and a longitude for a frame of reference around which the data point coordinates are situated.

At stage B, the client 101 computes simulation parameters for a reservoir model and communicates the simulation parameters to the distributed computing system 107. The simulation parameters comprise unconditional simulation parameters and conditional simulation parameters corresponding to an unconditional reservoir simulation and a conditional reservoir simulation respectively. Some or all of the simulation parameters can be computed by either the client 101 or the distributed computing system 107, and can be provided by an external source prior to operations shown in stages A-G. Certain values of simulation parameters can be hard coded into the distributed computing system 107. The simulation parameters further comprise parameters that specify sub-regions of the reservoir model (“tiles”) wherein the distributed computing system 107 will run localized conditional and unconditional simulations. Although not necessarily connected sub-regions, constructing the tiles as connected sub-regions of the reservoir model simplifies the required simulation parameters to specify sub-regions and enables efficiently parallelized simulations across the tiles. The parameters for the tiles contained in the simulation parameters can comprise sets of coordinates of data points in the reservoir models that make up the boundaries of tiles. Alternatively, the parameters can comprise coordinates for every data point in a tile.

At stage C, the controller node 109 sends unconditional simulation parameters received from the client 101 as well as reservoir data corresponding to the entire reservoir model to sub-nodes as represented by data 123. In some embodiments, some or all of the unconditional and/or conditional simulation parameters can be generated by the distributed computing system 107. The controller node 109 distributes the data 123 to each sub-node in an optimized order according to the configuration of the distributed computing system 107. Each sub-node receives a set of batches of data that it can simulate in parallel with other nodes such that downtime due to simulations terminating on a subset of the sub-nodes is minimized. in some embodiments, an optimal number of batches to send to each sub-node can be predetermined prior to running the simulations described herein. Values indicating which sub-nodes receive which batches of data can be hard coded into the distributed computing system 107.

The unconditional simulation parameters comprise an origin and directions for lines (“turning bands”), spacing and/or locations for sampling along the turning-bands, parameters for simulating a stochastic process along turning bands, a number of sub-nodes running the unconditional simulation, and a number of turning bands to assign to each sub-node. In order to compute the simulation parameters, the controller node 109 can generate a variogram based on the reservoir data received from the client 101 and can localize the variogram to a predetermined set of turning bands. The localized variogram for a turning band comprises descriptive statistics (mean, variance, probability density function type) for simulating the stochastic process along the turning bands. Each sub-node 111, 113, and 115 can simulate the stochastic process along a respective set of turning bands, and this computational step can be performed in parallel on each of the sub-nodes 111, 113, 115. Each sub-node can further maintain a queue of turning bands to be simulated in order. The number of sub-nodes running the unconditional simulation as well as the number of turning bands lines can be optimized with respect to the statistics of the reservoir data, the reservoir model size, the number of turning bands, etc. An example choice is 15 turning band lines. At stage D, once the sub-nodes generate the unconditional simulation, the sub-nodes 111, 113, and 115 send unconditional simulation results (as represented by data 121) comprising the simulated stochastic process along the turning bands to the controller node 109 to be stored in memory or, in some embodiments, to a shared memory database.

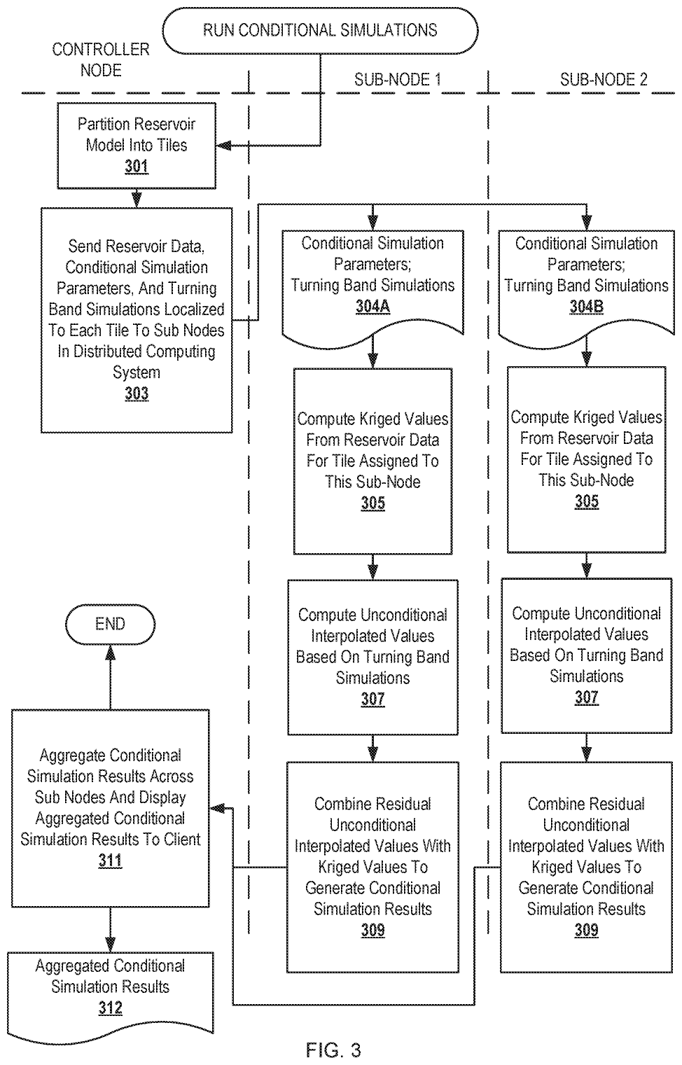

At stage E, the controller node 109 sends batches of data 123 to sub-nodes 111, 113, and 115. Each batch of data 123 comprises a subset of reservoir data corresponding to a partition of the reservoir model, conditional simulation parameters, and the unconditional simulation results generated at stage D. The conditional simulation parameters comprise coordinates within the partition to be simulated, variogram data and/or other statistics extracted from reservoir data, and reservoir data within the partition. Each sub-node 111, 113, and 115 receives a batch or multiple batches of data 123 and runs a conditional simulation that interpolates unconditional formation values using simulated turning bands contained in the unconditional simulation results and aligns the unconditional formation values with known formation values to create conditional simulation results. This alignment process is described in greater detail in the description for FIG. 3. Because each of the conditional simulations is for a distinct partition of the reservoir model, the conditional simulations can be run in isolation on separate sub-nodes in parallel. Moreover, the localization of conditional simulations can avoid possible accumulation of errors when aligning unconditional simulation results with known formation values and can increase the resolution achievable in the reservoir model with limited computing resources. At stage F, once the conditional simulations are finished, the sub-nodes send the conditional simulation results 125 to the controller node 109 and/or to a shared memory database.

At stage G, the controller node 109 aggregates conditional simulation results from each partition and sends the aggregated conditional simulation results 127 to the client 101. Th aggregated conditional simulation results comprise conditional simulation results for each tile arranged as prescribed by the overall reservoir model. The controller node can maintain in memory (e.g. in memory of the controller node 109 or shared memory) the arrangement of tiles in the reservoir model and each conditional simulation can comprise an identifier that associates the tile corresponding to the conditional simulation with a location in the reservoir model.

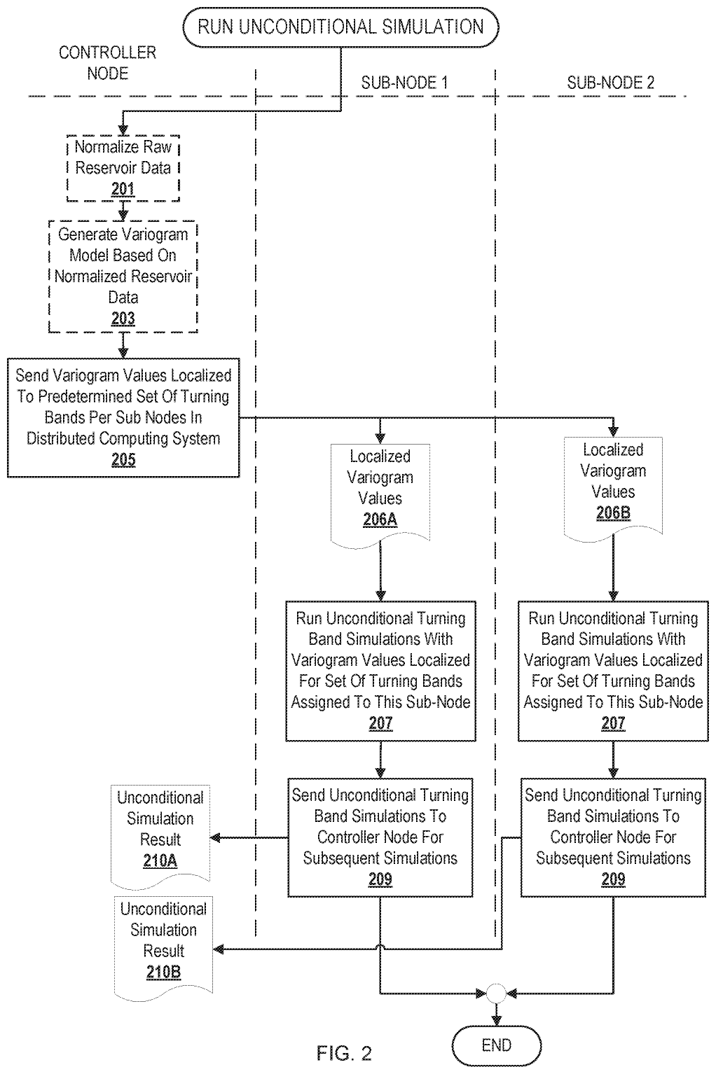

FIG. 2 is a flowchart of example operations for running an unconditional reservoir simulation using distributed computing. For consistency with earlier descriptions, operations in FIG. 2 are described with reference to a controller node and sub-nodes. These operations can be run on any distributed computing system configured for parallel computing. Nodes are arbitrary names for entities having computing resources. The operations in blocks 201, 203, and 205 are described as being performed by the controller node. All these operations can alternatively be provided to the distributed computing system by a client-facing interface. FIG. 2 only depicts 2 sub-nodes due to drawing sheet space constraints.

At block 201, the controller node receives raw reservoir data and unconditional simulation parameters, The raw reservoir data comprises a set of known and unknown data. points and reservoir model parameters indicating a reservoir size and boundary for the reservoir model. The controller node can extract formation property values corresponding to a chosen formation property type to be modeled from the reservoir data. For example, the reservoir model can be a pressure model and the controller node can extract known values for formation pressure along with coordinates for those values from the reservoir data. The controller node applies a transformation to the extracted formation values to be approximately distributed as a Gaussian distribution with a mean zero standard deviation one (“normalization”). This can be done by any number of standard techniques, for example by inverting the Gaussian cumulative distribution function using a frequency plot of the extracted formation values.

At block 203, the controller node generates a variogram model from the normalized reservoir data. The variogram model is a function that takes as inputs two locations in the reservoir model and outputs a measure of how much the formation values will vary at those locations, A higher value indicates that the stochastic process describing the formation for the reservoir model is more likely to take formation values at the two locations that have a large difference. If Z(x) is this stochastic process x is a location in the reservoir model), then the theoretical variogram m at two locations is precisely var(Z(x₁)−Z(x₂)), other words the variance of the difference between the value of the stochastic process at locations x₁ and x₂. The empirical variogram can be any standard numerical approximation of the above theoretical variogram. Techniques exploiting the structure of the reservoir data, for example binning dense neighborhoods of known data points, can be used in computing the empirical variogram. The variogram model (i.e. the “variogram” computed herein) is an approximation of the empirical variogram that interpolates values where the empirical variogram is not computed using a certain model function such as an exponential variogram model, a spherical variogram model, a Gaussian variogram model, etc. Thus, the empirical varioaram can be computed at a small fraction of the total locations and the variogram can be used to efficiently compute approximations of the empirical variogram at all locations. The controller node can distribute the empirical variogram computation to various sub-nodes in the distributed computing system. Depending on the method used to compute the empirical variogram and variogram, certain computational steps involving disparate sets of known data points can be performed in parallel. The empirical variogram can be computed between points in tiles corresponding to a partition of the reservoir model and along turning bands to save computation time. The controller node further determines tiles to assign to each sub-node or retrieves data indicating sub-node/tile assignments. The data indicating sub-node/tile assignments can be stored in the unconditional simulation parameters received at block 201 or can be stored in memory on the controller node.

Although blocks 201 and 203 are depicted in FIG. 2 as operations for running an unconditional reservoir simulation, these operations are depicted in dashed lines because they can be performed prior to running the unconditional simulation. The variogram values can be provided as inputs to the unconditional simulation and can be computed independently of the operations in FIG. 2. Moreover, the operations in 201 and 203 can occur simultaneous to the remaining operations in FIG. 2, and the controller node can distribute localized variogram values to sub-nodes as they are computed based on the empirical variogram.

At block 205, the controller node sends the localized variogram values to sub-nodes in the distributed computing system based on a partitioning of turning bands across sub-nodes. For each tile, first the controller node determines a subset of turning bands for that tile. This determination can be based on the proximity of the turning bands to the tile and a desired number of turning bands. Next, the controller node retrieves localized variogram values from the variogram computed at block 203 for the tile. These localized variogram values comprise model parameters and empirical variogram values at locations where the empirical variogram is computed. Sub-node 1 and sub-node 2 can be configured to recreate the variogram based on a type of variogram model and the model parameters. The controller node sends the localized variogram values 206A to sub-node 1 and localized variogram values 206B to the sub-node 2.

At block 207, each of the sub-nodes runs unconditional turning bands line simulations using the localized variogram values communicated from the controller node. Each sub-node generates a probability density function for the stochastic process Z(x) using the variogram values in the localized variogram for the sub-node. For example, the probability density function can be generated such that the variance of the difference of Z(x) at two locations is approximately the variogram value between those two locations. Generating the probability density function in this way ensures that the distributions along turning bands reflect anisotropic characteristics of the formation. Each sub-node then simulates the reservoir model along each set of turning bands assigned to the sub-node using the probability density function. For example, the sub-nodes can repeatedly sample and average a one-dimensional distribution corresponding to the probability density function at the discrete locations along the turning bands (m a Monte Carlo simulation). Any simulation technique, that samples the probability density function can be used. Since the distributions along each turning band are independent, the sub-nodes can compute each unconditional turning bands simulation in parallel without requiring intra-node communication during computations.

At block 209, the sub-nodes send the unconditional turning bands simulations results 2l0A, 210B to the controller node for subsequent (conditional) simulations. The controller node can store the unconditional turning bands simulations in shared memory and can concurrently store variogram values as computed in block 203 for later simulations.

FIG. 3 is a flowchart of example operations for partitioning a reservoir model and decomposing conditional reservoir simulation for the reservoir model across a distributed computing system based on the partitioning. For consistency with earlier descriptions, operations in FIG. 3 are described with reference to a controller node and sub-nodes. Although data is described as transferred between nodes, data can be stored in a shared memory database. FIG. 3 only depicts 2 sub-nodes due to drawing space constraints.

At block 301, the controller node partitions a reservoir model into tiles. The tile size/shape and partition configuration can be determined by the controller node or can be received from a client-facing interface. The partition (i.e. the set of tiles) is constructed such that each tile comprises a distinct set of locations in the reservoir model and the partition covers the entire reservoir model (i.e. no points in the reservoir model are outside the partition). The controller node can store a footprint of each tile in memory so that when it receives conditional simulation results at block 311, it can collate each tile corresponding to each conditional simulation to a location in the reservoir model.

At block 303, the controller node aggregates reservoir data, conditional simulation parameters, and turning band simulations localized to each tile. The reservoir data comprises formation values and locations within the corresponding tile. The conditional simulation parameters comprise variogram values between locations in the tile as well as turning parameters that vary depending on the type of conditional simulation. The turning band simulations are computed as described variously above in the description of FIG. 2. In certain embodiments, only a subset of turning bands can be aggregated for the tile, wherein the subset of turning bands corresponding to turnings band necessary for interpolation at locations in the tile. The controller node sends the aggregated reservoir data comprising conditional simulation parameters and turning band simulations 304A, 304B to the sub-nodes for conditional simulations.

At block 305, each of the sub-nodes computes kriged values using reservoir data for each tile. The kriged values are interpolated values within the reservoir model using known data points, and can be computed by any number of interpolation methods such as ordinary kriging, simple kriging, indicator kriging, lognormal kriging, etc. In ordinary kriging, for example, the interpolated values are a linear combination of values at known data points, where the weights are chosen so that the kriged values are minimum variance, unbiased estimates. In order to satisfy the constraints of minimum variance and zero bias, the weights can be solved as the solution to an optimization problem known as the “kriging system.” This optimization problem is localized to each tile which can significantly speed up solvers since the solution involves a computational bottleneck of inverting a square matrix with a number rows/column on the order of the number of known data points.

At block 307, each of the sub-nodes computes unconditional interpolate values in each file based on the turning bands simulations received at block 303. Many interpolation methods can be used. For example, within each tile the sub-nodes can project each unknown data point in the unconditional simulation for that tile onto every turning band corresponding to the tile. The interpolated value is then represented as a linear combination of the values of the turning bands simulations at the projections (or, the nearest discretized value along each turning band to the projection), where the weights are the dot product of a unit vector in the direction of the unknown data point and a unit vector in the direction of the turning hands. The interpolated values are computed at every unknown data point in the tile.

At block 309, each of the sub-nodes computes residual unconditional interpolated values that have value zero at known data points. The residual unconditional interpolated values can be computed, for example, by kriging the values of the unconditional simulation at the known data points and subtracting the kriged unconditional simulation from the unconditional interpolated values. Since kriging is unbiased, the kriged unconditional simulation and the unconditional interpolated values will have the same values at known data points. Consequently, the difference will have value zero at known. data points. The sub-nodes can generate conditional simulation results by adding the residual unconditional interpolated values (which represented heterogeneity in the formation) to the kriged values computed at block 305. Restricting the computational steps of interpolating unconditional values, computing residual unconditional interpolated values, and generating conditional simulation results to each tile can significantly reduce computational time for each of these steps. Each sub-node sends conditional simulation results to the controller node as the conditional simulations are completed.

The operations in blocks 305, 307, and 309 are performed independently for each tile. Consequently, these operations can be performed by various components of the distributed computing system in parallel. Each component of the distributed computing system can be assigned one or more tiles on which to run conditional simulations. The number of tiles assigned to each component and the number of components running the conditional simulations can be optimized. This optimization can depend on the size/shape of tiles, the number of tiles, the number of known and unknown data points in each tile/in the reservoir model, the statistics of the formation data, expert domain knowledge, etc. The optimization can be precomputed before deployment of the distributed computing system or can be automatically generated based on any of the above considerations.

At block 311, the conditional simulation results from each tile are aggregated by the controller node across sub-nodes. Conditional simulation results can be aggregated in a stream as computation finishes on sub-nodes. The aggregation step is implemented as described variously above and generates aggregated conditional simulation results 312 for display to a client.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel, and the operations may be performed in a different order. For example, the operations depicted in blocks 305, 307, and 309 can be performed in parallel or concurrently. With respect to FIG. 2, block 209 is not necessary for some embodiments.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object-oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

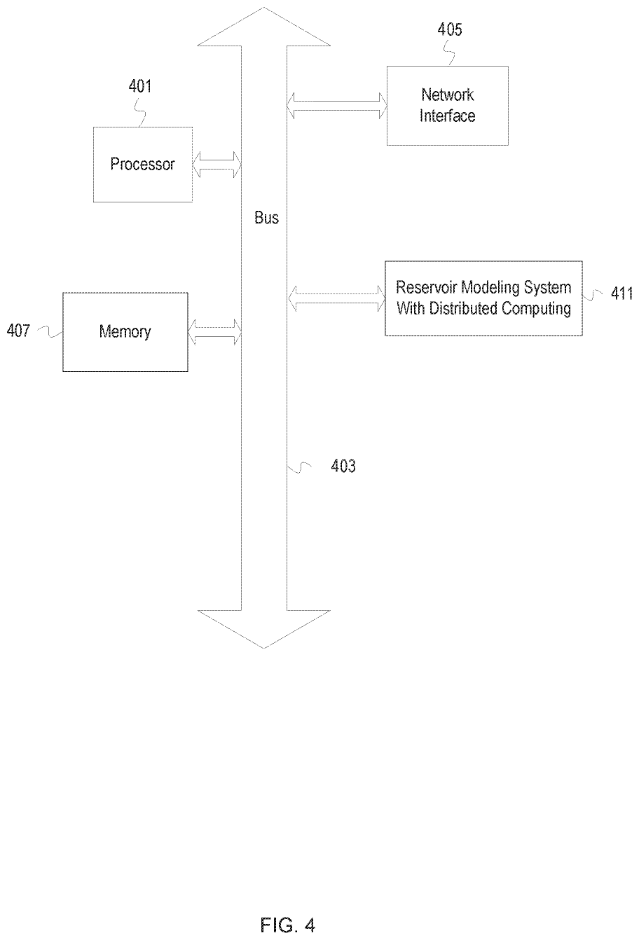

FIG. 4 depicts an example computer system with a reservoir modeling system that implements distributed computing. The computer system includes a processor unit 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes a reservoir modeling system with distributed computing 411. The reservoir modeling system with distributed computing 411 can efficiently model a reservoir by decomposing the reservoir model into tiles and running sub models on each tile as described previously. Any one of the previously described functionalities may be partially (or entirely) implemented in hardware and/or on the processor unit 401. For example, the functionality may be implemented with an application-specific integrated circuit, in logic implemented in the processor unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401 and the network interface 405 are coupled to the bus 403. Although illustrated as being coupled to the bus 403, the memory 407 may be coupled to the processor unit 401.

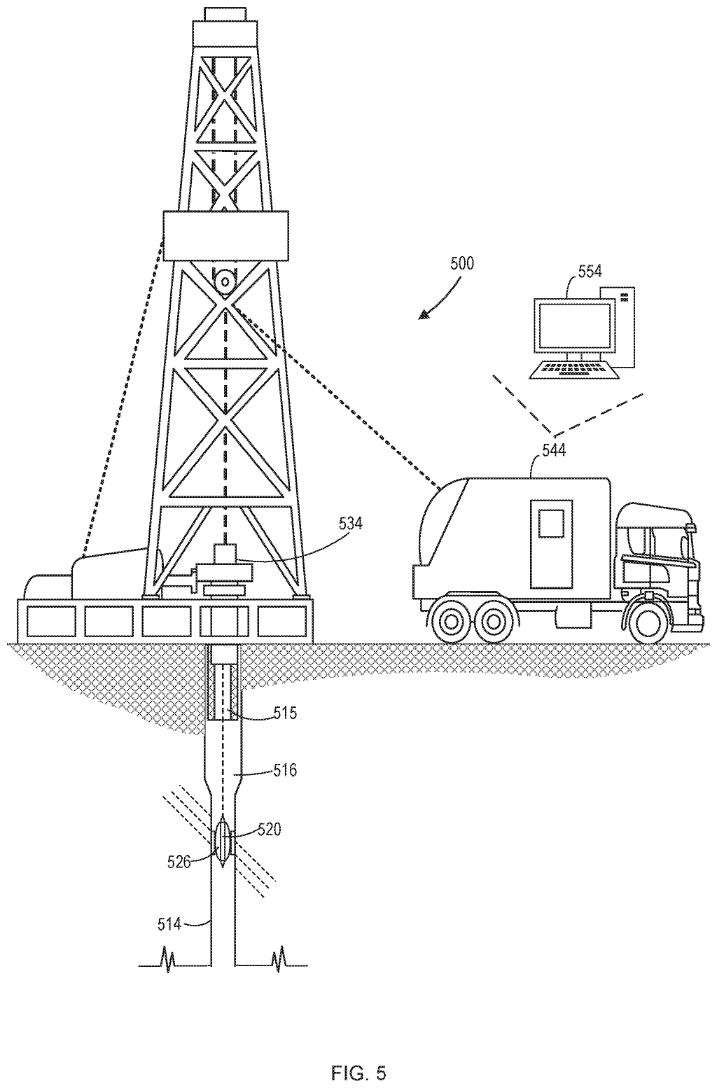

FIG. 5 depicts a schematic diagram of a wireline system with a reservoir modeling system that implements distributed computing. A system 500 can be used in an illustrative logging environment with a drillstring removed, in accordance with some embodiments of the present disclosure.

Subterranean operations may be conducted using a wireline system 520 once the drillstring has been removed, though, at times, some or all of the drillstring may remain in a borehole 514 during logging with the wireline system 520. The wireline system 520 may include one or more logging tools 526 that may be suspended in the borehole 514 by a conveyance 515 (e.g., a cable, slickline, or coiled tubing). The logging tool 526 may be communicatively coupled to the conveyance 515. The conveyance 515 may contain conductors for transporting power to the wireline system 520 and telemetry from the logging tool 526 to a logging facility 544. The logging facility 544 comprises a reservoir modeling system with distributed computing 554 that can efficiently model a reservoir by decomposing the reservoir model into tiles and running sub models on each tile as described variously above. Alternatively, the conveyance 515 may lack a conductor, as is often the case using slickline or coiled tubing, and the wireline system 520 may contain a control unit 534 that contains memory, one or more batteries, and/or one or more processors for performing operations and storing measurements.

In certain embodiments, the control unit 534 can be positioned at the surface, in borehole (e.g., in the conveyance 515 and/or as part of the logging tool 526) or both (e.g., a portion of the processing may occur downhole and a portion may occur at the surface). The control unit 534 may include a control system or a control algorithm. In certain embodiments, a control system, an algorithm, or a set of machine-readable instructions may cause the control unit 534 to generate and provide an input signal to one or more elements of the logging tool 526, such as the sensors along the logging tool 526. The input signal may cause the sensors to be active or to output signals indicative of sensed properties. The logging facility 544 (shown in FIG. 5 as a truck, although it may be any other structure) may collect measurements from the logging tool 526, and may include computing facilities for controlling, processing, or storing the measurements gathered by the logging tool 526. The computing facilities may be communicatively coupled to the logging tool 526 by way of the conveyance 515 and may operate similarly to the control unit 534. In certain example embodiments, the control unit 534, which may be located in logging tool 526, may perform one or more functions of the computing facility.

The logging tool 526 includes a mandrel and a number of extendible arms coupled to the mandrel. One or more pads are coupled to each of the extendible arms. Each of the pads have a surface facing radially outward from the mandrel. Additionally, at least a sensor is disposed on the surface of each pad. During operation, the extendible arms are extended outwards to a wall of the borehole to extend the surface of the pads outward against the wall of the borehole. The sensors of the pads of each extendible arm can detect image data to create captured images of the formation surrounding the borehole.

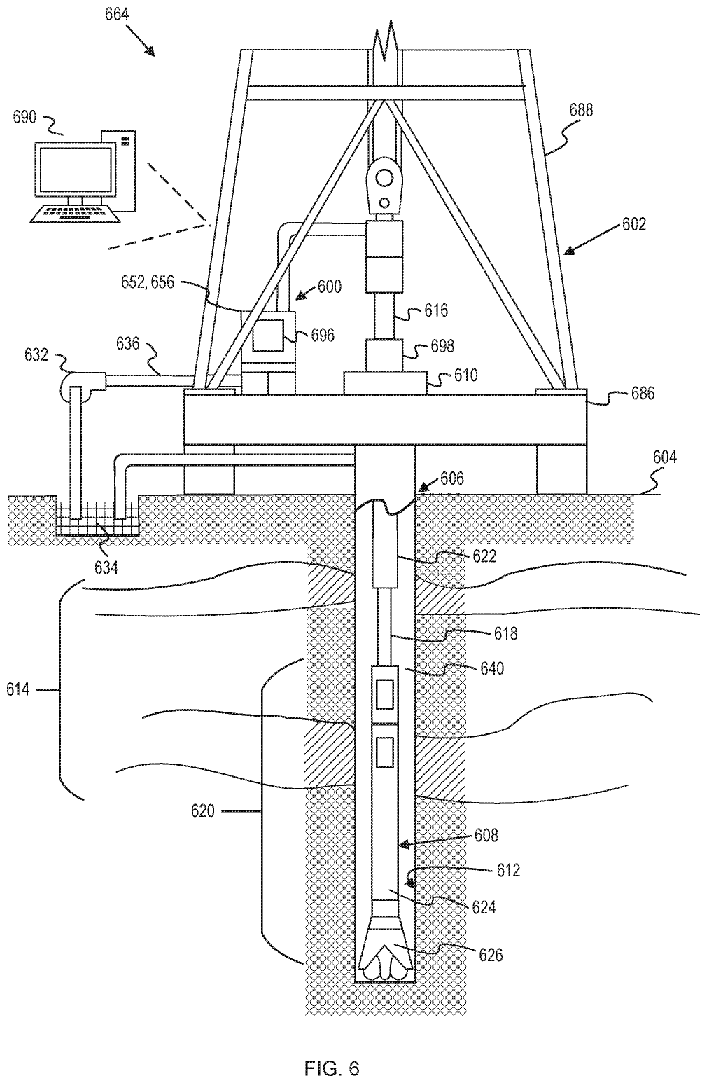

FIG. 6 is a schematic diagram of a drilling rig system with a reservoir modeling system that implements distributed computing. For example, in FIG. 6 it can be seen how a system 664 may also form a portion of a drilling rig 602 located at the surface 604 of a well 606. Drilling of oil and gas wells is commonly carried out using a string of drill pipes connected together so as to form a drilling string 608 that is lowered through a rotary table 610 into a wellbore or borehole 612. Here a drilling platform 686 is equipped with a derrick 688 that supports a hoist. A reservoir modeling system with distributed computing 690 can be communicatively coupled to any measurements devices attached to the system 664 and can efficiently model a reservoir by decomposing the reservoir model into tiles and running sub models on each tile as described variously above.

The drilling rig 602 may thus provide support for the drill string 608. The drill string 608 may operate to penetrate the rotary table 610 for drilling the borehole 612 through subsurface formations 614. The drill string 608 may include a Kelly 616, drill pipe 618, and a bottom hole assembly 620, perhaps located at the lower portion of the drill pipe 618.

The bottom hole assembly 620 may include drill collars 622, a down hole tool 624, and a drill bit 626. The drill hit 626 may operate to create a borehole 612 by penetrating the surface 604 and subsurface formations 614. The down hole tool 624 may comprise any of a number of different types of tools including MWD tools, LWD tools, and others.

During drilling operations, the drill string 608 (perhaps including the Kelly 616, the drill pipe 618, and the bottom hole assembly 620) may be rotated by the rotary table 610. In addition to, or alternatively, the bottom hole assembly 620 may also be rotated by a motor (e.g., a mud motor) that is located down hole. The drill collars 622 may be used to add weight to the drill bit 626. The drill collars 622 may also operate to stiffen the bottom hole assembly 620, allowing the bottom hole assembly 620 to transfer the added weight to the drill bit 626, and in turn, to assist the drill bit 626 in penetrating the surface 604 and subsurface formations 614.

During drilling operations, a mud pump 632 may pump drilling fluid (sometimes known by those of ordinary skill in the art as “drilling mud”) from a mud pit 634 through a hose 636 into the drill pipe 618 and down to the drill bit 626. The drilling fluid can flow out from the drill bit 626 and be returned to the surface 604 through an annular area 640 between the drill pipe 618 and the sides of the borehole 612. The drilling fluid may then be returned to the mud pit 634, where such fluid is filtered. In some embodiments, the drilling fluid can be used to cool the drill bit 626, as well as to provide lubrication for the drill bit 626 during drilling operations.

Additionally, the drilling fluid may be used to remove subsurface formation 614 cuttings created by operating the drill bit 626. It is the images of these cuttings that many embodiments operate to acquire and process.

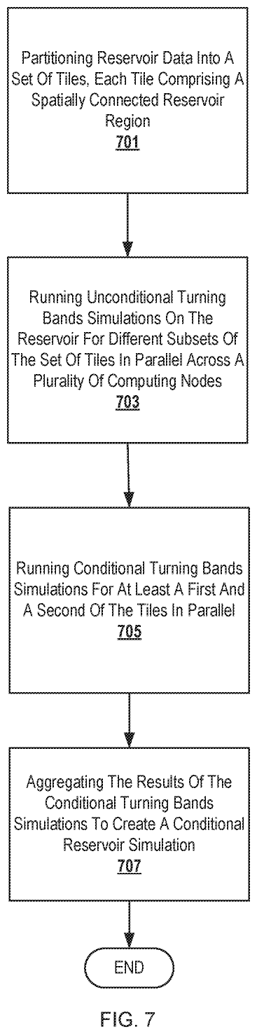

FIG. 7 is a flowchart of example operations for running a conditional reservoir simulation. For consistency with earlier descriptions, operations in FIG. 7 are described with reference to a controller node and sub-nodes. Although data is described as transferred between nodes, data can be stored in a shared memory database.

At block 701, a controller node partitions reservoir data into a set of tiles. Each tile comprises a spatially connected reservoir region. The controller node can partition the reservoir data according to any design considerations given previously and can store the partition as a footprint in its' own memory, the memory of sub-nodes, and shared memory as described variously above.

At block 703, the controller node sends unconditional simulation parameters to sub-nodes. The sub-nodes run unconditional turning bands simulations based on the received unconditional simulation parameters. Each sub node can run unconditional turning bands simulations on turning bands that correspond to one or multiple tiles and can run in parallel. Operational considerations of assigning sub-nodes to turning bands can be optimized as described variously above.

At block 705, the controller node sends conditional simulation parameters to sub-nodes. The sub-nodes run conditional turning bands simulations based on the conditional simulation parameters. At least a first and a second sub-node run conditional turning bands simulations on a first and a second of the tiles respectively, in parallel. The sub-nodes can be configured to run conditional turning band simulations based on received conditional simulation parameters as described variously above.

At block 707, the controller node aggregates the results of the conditional turning bands simulations according to the partition determined at block 701 and creates a conditional reservoir simulation. The controller node can aggregate conditional turning bands simulations using a footprint of the partitioning of reservoir data computed at block 701, as described variously above.

While the aspects of the disclosure are described with reference to various implementations and exploitations, it will be understood that these aspects are illustrative and that the scope of the claims is not limited to them. In general, techniques for reservoir modeling as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

### Example Embodiments

Example embodiments can include the following:

Embodiment 1: A method comprising partitioning reservoir data for a reservoir into a set of tiles, each tile comprising a spatially connected reservoir region, running unconditional turning bands simulations on the reservoir data for different subsets of the set of tiles in parallel across a plurality of computing nodes, running conditional turning bands simulations for each tile in the set of tiles in parallel across the plurality of computing nodes, and aggregating results of the conditional turning hands simulations to create a conditional reservoir simulation.

Embodiment 2: The method of embodiment 1, further comprising localizing a variogram for the spatially connected reservoir region, wherein localizing the variogram comprises computing variogram values for data points within each tile, wherein running the unconditional turning bands simulations comprises running the unconditional turning bands simulations for at least a first tile and a second of the set of tiles in parallel, wherein running the unconditional turning band simulation for the first tile is with first localized variogram values for a first set of one or more turning bands associated with the first tile and running the unconditional turning band simulation for the second tile is with second localized variogram values for a second set of one or more turning bands associated with the second tile.

Embodiment 3: The method of any of embodiments 1-2, wherein running the conditional turning bands simulation for a tile comprises, computing kriged values for a set of locations in the tile based on the reservoir data, computing unconditional interpolated values for the set of locations in the tile based on results of the unconditional turning bands simulations, and combining the kriged values with the unconditional interpolated values.

Embodiment 4: The method of any of embodiments 1-3, further comprising collating the results of the conditional turning bands simulations according to coordinates of the set of tiles, wherein the aggregating is based on the collating.

Embodiment 5: The method of any of embodiments 1-4, further comprising aggregating results of the unconditional turning bands simulations and providing the aggregated unconditional turning bands simulations results for the conditional turning bands simulations.

Embodiment 6: The method of any of embodiments 1-5, further comprising indicating the conditional reservoir simulation for display.

Embodiment 7: A non-transitory, computer-readable medium having instructions stored thereon that are executable by a computing device to perform operations comprising, partitioning reservoir data for a reservoir into a set of tiles, each tile comprising a spatially connected reservoir region, running unconditional turning bands simulations on the reservoir data for different subsets of the set of tiles in parallel across a plurality of computing nodes, running conditional turning bands simulations for each tile in the set of tiles in parallel across the plurality of computing nodes, and aggregating results of the conditional turning bands simulations to create a conditional reservoir simulation.

Embodiment 8: The computer-readable medium of embodiment 7, further comprising instructions executable by the computing device to localize a variogram for the spatially connected reservoir region, wherein localizing the variogram comprises computing variogram values for data points within each tile, wherein running the unconditional turning bands simulations comprises miming the unconditional turning bands simulations for at least a first tile and a second of the set of tiles in parallel, wherein running the unconditional turning band simulation for the first tile is with first localized variogram values for a first set of one or more turning hands associated with the first tile and running the unconditional turning hand simulation for the second tile is with second localized variogram values for a second set of one or more turning bands associated with the second tile.

Embodiment 9: The computer-readable medium of any of embodiments 7-8, wherein the instructions executable by the computing device to run the conditional turning bands simulation for a tile comprise instructions to,

Embodiment 10: The computer-readable medium of any of embodiments 7-9, further comprising instructions executable by the computing device to collate the results of the conditional turning bands simulations according to coordinates of the set of tiles, wherein the aggregating is based on the collating.

Embodiment 11: The computer-readable medium of any of embodiments 7-10, further comprising instructions executable by the computing device to aggregate results of the unconditional turning bands simulations and provide the aggregated unconditional turning bands simulations results for the conditional turning bands simulations.

Embodiment 12: The computer-readable medium of any of embodiments 7-11, further comprising instructions executable by the computing device to indicate the conditional reservoir simulation for display.

Embodiment 13: The computer-readable medium of any of embodiments 7-12, further comprising instructions executable by the computing device to control a drilling operation based on the conditional reservoir simulation.

Embodiment 14: An apparatus comprising a processor, and a computer-readable medium having instructions stored thereon that are executable by the processor to cause the apparatus to partition reservoir data for a reservoir into a set of tiles, each tile comprising a spatially connected reservoir region, nun unconditional turning bands simulations on the reservoir data for different subsets of the set of tiles in parallel across a plurality of computing nodes, run conditional turning bands simulations for each tile in the set of tiles in parallel across the plurality of computing nodes, and aggregate results of the conditional turning bands simulations to create a conditional reservoir simulation.

Embodiment 15: The apparatus of embodiment 14, further comprising instructions executable by the processor to cause the apparatus to localize a variogram for the spatially connected reservoir region, wherein localizing the variogram comprises computing variogram values for data points within each tile, wherein running the unconditional turning bands simulations comprises miming the unconditional turning bands simulations for at least a first tile and a second of the set of tiles in parallel, wherein running the unconditional turning band simulation for the first tile is with first localized variogram values for a first set of one or more turning bands associated with the first tile and running the unconditional turning band simulation for the second tile is with second localized variogram values for a second set of one or more turning bands associated with the second tile.

Embodiment 16: The apparatus of any of embodiments 14-15, wherein the instructions executable by the processor to cause the apparatus to run the conditional turning bands simulation for a tile comprise instructions to, compute kriged values for a set of locations in the tile based on the reservoir data, compute unconditional interpolated values for the set of locations in the tile based on results of the unconditional turning bands simulations, and combine the kriged values with the unconditional interpolated values.

Embodiment 17: The apparatus of any of embodiments 14-16, further comprising instructions executable by the processor to cause the apparatus to collate the results of the conditional turning bands simulations according to coordinates of the set of tiles, wherein the aggregating is based on the collating.

Embodiment 18: The apparatus of any of embodiments 14-17, further comprising instructions executable by the processor to cause the apparatus to aggregate results of the unconditional turning bands simulations and provide the aggregated unconditional turning bands simulations results for the conditional turning bands simulations.

Embodiment 19: The apparatus of any of embodiments 14-18, further comprising instructions executable by the processor to cause the apparatus to indicate the conditional reservoir simulation for display.

Embodiment 20: The apparatus of any of embodiments 14-19, further comprising instructions executable by the processor to cause the apparatus to control a drilling operation based on the conditional reservoir simulation.

What is claimed is:

1. A method comprising:
partitioning reservoir data for a reservoir into a set of tiles, each comprising a spatially connected reservoir region;
running unconditional turning hands simulations on the reservoir data for different subsets of the set of tiles in parallel across a plurality of computing nodes;
running conditional turning bands simulations for each tile in the set of tiles in parallel across the plurality of computing nodes; and
aggregating results of the conditional turning hands simulations to create a conditional reservoir simulation.

2. The method of claim 1, further comprising:
localizing a variogram for the spatially connected reservoir region, wherein localizing the variogram comprises computing variogram values for data points within each tile.
wherein running the unconditional turning bands simulations comprises running the unconditional turning bands simulations for at least a first tile and a second of the set of tiles in parallel,
wherein running the unconditional turning band simulation for the first tile is with first localized variogram values for a first set of one or more turning bands associated with the first tile and running the unconditional turning hand simulation for the second tile is with second localized variogram values for a second set of one or more turning bands associated with the second tile.

3. The method of claim I, wherein running the conditional turning bands simulation a tile comprises,
computing kriged values for a set of locations in the tile based on the reservoir data;
computing unconditional interpolated values for the set of locations in the tile based on results of the unconditional turning bands simulations; and
combining the kriged values with the unconditional interpolated values.

4. The method of claim 1, further comprising collating the results of the conditional turning bands simulations according to coordinates of the set of tiles, wherein the aggregating is based on the collating.

5. The method of claim 1, further comprising aggregating results of the unconditional turning bands simulations and providing the aggregated unconditional turning bands simulations results for the conditional turning bands simulations.

6. The method of claim 1, further comprising indicating the conditional reservoir simulation for display.

7. A non-transitory, computer-readable medium having instructions stored thereon that are executable by a computing device to perform operations comprising:
partitioning reservoir data for a reservoir into a set of tiles, each tile comprising a spatially connected reservoir region;
running unconditional turning bands simulations on the reservoir data for different subsets of the set of tiles in parallel across a plurality of computing nodes;
running conditional turning bands simulations for each tile in the set of tiles in parallel across the plurality of computing nodes; and
aggregating results of the conditional turning bands simulations to create a conditional reservoir simulation,

8. The computer-readable medium of claim 7, further comprising instructions executable by the computing device to:
localize a variogram for the spatially connected reservoir region, wherein localizing, the variogram comprises computing variogram values for data points within each tile,
wherein running the unconditional turning bands simulations comprises running the unconditional turning bands simulations for at least a first tile and a second of the set of tiles in parallel,
wherein running the unconditional turning band simulation for the first tile is with first localized variogram values for a first set of one or more turning bands associated with the first tile and running the unconditional turning band simulation for the second tile is with second localized variogram values for a second set of one or more turning bands associated with the second tile.

9. The computer-readable medium of claim 7, wherein the instructions executable by the computing device to run the conditional turning bands simulation for a tile comprise instructions to,
compute kriged values for a set of locations in the tile based on the reservoir data;
compute unconditional interpolated values for the set of locations in the tile based on results of the unconditional turning hands simulations; and
combine the kriged values with the unconditional interpolated values.

10. The computer-readable medium of claim 7, further comprising instructions executable by the computing device to collate the results of the conditional turning bands simulations according to coordinates of the set of tiles, wherein the aggregating is based on the collating.

11. The computer-readable medium of claim 7, further comprising instructions executable by the computing device to aggregate results of the unconditional turning bands simulations and provide the aggregated unconditional turning bands simulations results for the conditional turning bands simulations.

12. The computer-readable medium of claim 7, further comprising instructions executable by the computing device to indicate the conditional reservoir simulation for display.

13. The computer-readable medium of claim 7, further comprising instructions executable by the computing device to control a drilling operation based on the conditional reservoir simulation.

14. An apparatus comprising:
a processor; and
a computer-readable medium having instructions stored thereon that are executable by the processor to cause the apparatus to:
partition reservoir data for a reservoir into a set of tiles, each tile comprising a spatially connected reservoir region;
run unconditional turning bands simulations on the reservoir data for different subsets of the set of tiles in parallel across a plurality of computing nodes;
run conditional turning bands simulations for each tile in the set of tiles in parallel across the plurality of computing nodes; and
aggregate results of the conditional turning bands simulations to create a conditional reservoir simulation.

15. The apparatus of claim 14, further comprising instructions executable by the processor to cause the apparatus to:
localize a variogram for the spatially connected reservoir region, wherein localizing the variogram comprises computing variogram values for data points within each tile,
wherein running the unconditional turning bands simulations comprises running the unconditional tuning bands simulations for at least a first tile and a second of the set of tiles in parallel,
wherein running the unconditional turning band simulation for the first tile is with first localized variogram values for a first set of one or more turning bands associated with the first tile and running the unconditional turning band simulation for the second tile is with second localized variogram values for a second set of one or more turning bands associated with the second tile.

16. The apparatus of claim 14, wherein the instructions executable by the processor to cause the apparatus to run the conditional turning bands simulation for a tile comprise instructions to,
compute kriged values for a set of locations in the tile based on the reservoir data;
compute unconditional interpolated values for the set of locations in the tile based on results of the unconditional turning bands simulations; and
combine the kriged values with the unconditional interpolated values.

17. The apparatus of claim 14, further comprising instructions executable by the processor to cause the apparatus to collate the results of the conditional turning bands simulations according to coordinates of the set of tiles, wherein the aggregating is based on the collating.

18. The apparatus of claim 14, further comprising instructions executable by the processor to cause the apparatus to aggregate results of the unconditional turning bands simulations and provide the aggregated unconditional turning hands simulations results for the conditional turning hands simulations.

19. The apparatus of claim 14, further comprising instructions executable by the processor to cause the apparatus to indicate the conditional reservoir simulation for display.

20. The apparatus of claim 14, further comprising instructions executable by the processor to cause the apparatus to control a drilling operation based on the conditional reservoir simulation.
